(19) United States
(12) Patent Application Publication
(10) Pub. No.: US 2006/0259294 A1
(43) Pub. Date: Nov. 16, 2006

(54) Voice recognition system and method

(76) Inventor: John Tashereau, Vancouver (CA)

Correspondence Address: DAVIS WRIGHT TREMAINE, LLP, 2600 CENTURY SQUARE, 1501 FOURTH AVENUE, SEATTLE, WA, 98101-1688, US

(21) Appl. No.: 10/539,155

(22) PCT Filed: Dec. 16, 2003
(86) PCT No.: PCT/CA03/01948

§ 371 Date: Jul. 5, 2006

Related U.S. Application Data
(60) Provisional application No. 60/433,506, filed on Dec. 16, 2002.

(30) Foreign Application Priority Data
Feb. 21, 2003 (CA) 2,419,526

(51) Int. Cl. G06F 17/21

(52) U.S. Cl. 704/10

(57) ABSTRACT

A method of matching an utterance comprising a word to a listing in a directory using an automated speech recognition system by forming a word list comprising a selection of words from the listings in the directory; using the automated speec recognition system to determine the best possible matches of the word in the utterance to the words in the word list; creating a grammar of listings in the directory that contain at least one of the best possible matches; and using the automated speech recognition system to match the utterance to a listing within the grammar.

### NOTICE REGARDING COPYRIGHTED MATERIAL

A portion of the disclosure of this patent document contains material subject to copyright protection. The copyright owner has no objection to the facsimile reproduction by anyone of the patent document or the patent disclosure as it appears in the public Patent Office file or records but otherwise reserves all copyright rights whatsoever.

### TECHNICAL FIELD

This invention relates to systems and methods of voice recognition, and more particularly voice recognition used in the context of directory assistance.

### BACKGROUND

Automatic Speech Recognition (“ASR”) is commonly used in directory assistance systems. The use of the term “ASR systems” in this document includes signal processing systems for the purposes of evaluating audio signals and determining corresponding phonetic, word or sentence results. By automating the replies to telephone number inquiries, significant savings can be realized by telecommunications providers.

An important part of the development of voice recognition based systems is the creation of vocabularies (herein referred to as “grammars”) which represent and define the words a speech recognition system can “hear”. Grammars are developed and coded on computer systems through means known in the art such as programmatic textual representation, and articulate the words, phrases and sentences (herein referred to as “utterances”) which the ASR system listens to and attempts to match against the grammar to provide a result.

In practice, ASR systems are designed and used to accept utterances, and qualify possible matches within the defined grammar as rapidly as possible to return one or more of the best qualified matches.

A significant limitation with ASR systems in the prior art is that as a grammar's size increases, its accuracy diminishes. This occurs because as the number of possible phonetic matches for an utterance increase, the probability for error also increases as the differences between the various possible matches is smaller, (i.e. each possible match become less distinct).

Another limitation is the actual period of time ASR systems require to perform a matching process. As the size of a grammar increases the time required to return a match to an utterance increases. Additional processing time is required to evaluate the increased number of possibilities.

A further limitation of grammars is that of word order. Grammars are generally defined in a manner which matches an expected word order (for example if the grammar contains “St. Christopher's Hospital”, it will be defined to hear the words “Saint” and “Christopher” in that order). If a given utterance's word order does not significantly match that described in the grammar, a match may not be made or an incorrect match may be generated. In practice, an utterance of a word order which differs from that defined in a grammar can produce very poor results, especially in cases where other possible matches using the same or similar words exists.

Another limitation is size. Grammars of significant size (over a few thousand entries) represent several implementation and performance issues. Large grammars can be significantly difficult to load into an ASR system and indeed may not load at all, or may not load in sufficient time to provide a useable or natural conversational “dialog” with a user.

It is common practice to split large grammars (which cannot viably operate) into more specific and smaller grammars. The user is engaged to provide additional input to direct the system to the appropriate smaller grammar. For example, it is common practice to ask a user “What kind of business would you like to find?”. The requester responds with a business type, for example, “restaurants” and the ASR system proceeds using a smaller grammar of businesses categorized as “restaurants” as opposed to a larger grammar of all businesses. If necessary this can be repeated, for example by asking “What type of restaurant are you looking for?”. While this increases accuracy, it diminishes the quality of the interaction and increases costs, as additional dialog with the user is required to provide direction to the ASR system. In practical applications, these additional questions often appear unnatural and diminish the conversational quality desired in ASR systems; increase the overall time associated with obtaining the desired result; and increase the interaction duration, which in turn increases costs.

A further limitation of large grammars is that they are commonly “pre-compiled”. Pre-compiling helps alleviate the run-time size limitation previously noted, however, pre-compiled grammars by nature cannot be dynamically generated in real-time. As a grammar articulates an end result, it is very difficult to implement a large grammar in pre-compiled form which is able to reference dynamic data.

In common practice, the described limitations associated with large grammars limit the practical application of ASR systems in real world solutions. A goal of ASR systems is to minimize the recognition speed required to respond to the user's request. Recognition speed in an ASR system varies depending on several factors, including: (1) grammar size, (2) grammar complexity, (3) desired accuracy, (4) available processor power and (5) quality and character of the input acoustic utterance. Without properly adjusting a grammar of about 10,000 words using ASR adjustments known in the art, it can take 2-3 minutes to recognize a 2-3 word utterance. Prior art ASR systems have “pruning” abilities to taper and adjust the grammar so that it requires 6-8 seconds to recognize a 2-3 word utterance. This duration can (and frequently does) go as high as 12 to 18 seconds on a fast computer.

In common practice, ASR is applied as a “one shot” process whereby the ASR system is applied “live” while the person is speaking and expected to return a result within a “reasonable” period of time. A reasonable time is that regarded as suitable for conversational purposes, i.e. about 2-3 seconds maximum, and ideally, about 1-2. If this is attempted with a 10,000 word grammar, the ASR process will likely take too much time, even for a grammar of only about 10,000 words. For large cities, the grammars can exceed 250,000 words, which require magnitudes of time where processes will commonly timeout and/or are well beyond what can be expected as reasonable.

Most directory assistance programs use a technique commonly known as “store and forward”. These partially automated directory assistance systems prompt the user for answers to questions (i.e. “inputs”), record the answers, and save the answers in temporary storage. Once all of the inputs have been collected from the user, and just before the operator comes online, the inputs are “whispered” to the operator, thereby keeping conversation between the operator and user to a minimum. In such a system the questions are preset, so that the pattern of question/answer will always be the same.

Some directory assistance systems integrate the “store and forward” system with an ASR system. In such an integrated system, the path chosen (by way of the questions asked) varies depending on the answers to the questions. Therefore, when using such a system, the user will not receive a consistent range of questions, depending on his or her answers. When the user answers a question or questions, and the system determines that the ASR system can manage the response, the user is then placed on a voice recognition track and asked the questions appropriate for that track (which are generally asked in an attempt to reduce the relevant grammar to a manageable level). These questions are quite different from those asked in the “store and forward” track, so a repeat user can usually quickly determine which track they have been placed on.

A further limitation with ASR systems is that they often have difficulty understanding the utterances provided by the user. ASR systems are set to “hear” an utterance at a specified volume, which may not be appropriate for the situation at hand. For example, a user with a low voice may not be understood properly. Likewise, background noise, such as traffic, can cause difficulties in “hearing” the user's utterances.

There have been attempts to overcome these limitations of ASR systems by improving the efficiency of a single pass, for example as described in U.S. Pat. No. 6,625,600 to Lyudovyk et al.

### SUMMARY OF THE INVENTION

The method and processes described herein implement technologies for ASR systems that are especially useful in applications where the possible utterances represent a large or very large collection of possibilities (i.e. a large grammar is required).

The method and processes address functional and accuracy problems associated with using ASR systems in general, and in particular, cases where large ASR “grammars” are required.

The method and processes described herein are described with respect to telephone directory assistance systems although the process is not limited to such application and can be used in situations wherever voice recognition is used, including mobile phone interfaces, in-vehicle systems, and the like.

The invention allows for the creation of proportionally much smaller ASR grammars than conventionally required for the same task and yet which yield substantially increased output accuracy.

### BRIEF DESCRIPTION OF FIGURES

Further objects, features and advantages of the present invention will become more readily apparent to those skilled in the art from the following description of the invention when taken in conjunction with the accompanying drawings, in which:

FIG. 1 is a typical list of business names and related information representing a small sample of a larger grammar;

FIG. 2 is a list of “items”;

FIG. 3 is a list of transformations carried out on the items;

FIG. 4 is a word map based on the transformed listings;

FIG. 5 is a word map statistical analysis;

FIGS. 6 through 8 are samples of word map to item illustrations;

FIG. 9 is a flow chart showing the process of a “store and forward” system;

FIG. 10 is a flow chart showing a prior art “store and forward” system integrated with a voice recognition system;

FIG. 11 is a flow chart showing a voice recognition system using the described invention;

FIG. 12 is a list of results from an ASR system acting on a Word List according to the invention; and

FIGS. 13 and 14 the contents of dynamic grammars created by an ASR system according to the invention acting on the Word List as described above.

### DETAILED DESCRIPTION OF PREFERRED EMBODIMENTS

The process and system according to the invention address the functional performance problems of accuracy, speed, utterance flexibility, interface expectations and usability, target data flexibility and resource requirements associated with large grammars in ASR systems.

In common practice, a grammar is generated and designed for “single execution”. That is, a grammar is generated knowing that the ASR technology will perform a “single pass” on the grammar attempting to match a possible utterance and will return the corresponding candidates. The grammar is generally designed to encompass as many utterances as reasonably possible. In the system according to the invention, a grammar is designed to be as small as possible. The grammar is dynamically generated knowing that the ASR system will be used again to perform one or more latent, and optionally concurrent, recognitions, each latent recognition evaluating the terms from a previous recognition process. The grammar is dynamically generated such that the terms represented in the grammar can lead to as many possible results as required. The grammar is also generated to be as small as possible or required and for the desired level of accuracy given the characteristics of the words in the grammar. Finally, the grammar will contain many disparate terms so that the ASR system will be more capable of determining the differences between the terms.

The process is facilitated by recording or saving the original utterance of the user as applied to the initial or first grammar and applying the same utterance to subsequent grammars which are dynamically generated (or may have been previously generated). Each latent recognition evaluates the utterance against a grammar which is used to either prove or disprove a possible result. The latent grammars may be dynamically or previously generated. The grammar target, that is the information being referenced by a grammar and which is used to create a grammar, can also be dynamically changing (for example it can be a Word List or a grammar). This process allows the original primary grammar to be used to dynamically generate a grammar at run time, even though is it representing a large data set which normally calls for pre-compiled grammars.

In a preferred embodiment, the utterance is not re-presented to the user (i.e.: the user does not hear the original utterance even though it is used more than once). Also, in a preferred embodiment, the time taken for the process is minimized by means such as using concurrent processing or iterations, or engaging a caller is in another dialog. Also gain control (i.e. adjustment of the recording sensitivity) can be used to increase the sensitivity and loudness of the original user utterance. Generally, increasing the gain results in better recognition of the utterance. Futhermore, control of the gain applied to the recorded or stored utterance for latent recognitions (in addition to the original gain applied to the source utterance) can be used as a variable to enhance accuracy of the ASR process.

The use of a recorded utterance also allows multiple passes to be applied quickly through the grammars. As the utterance will be in data form it can be very quickly input into the recognizer (i.e. a five second utterance will not take twenty seconds to pass through four times).

The preferred ASR system according to the invention will go through the following steps as described below:
1. Transformation
2. Word Map
3. Grammar Generation
4. Grammar Interpretation
   Transformation

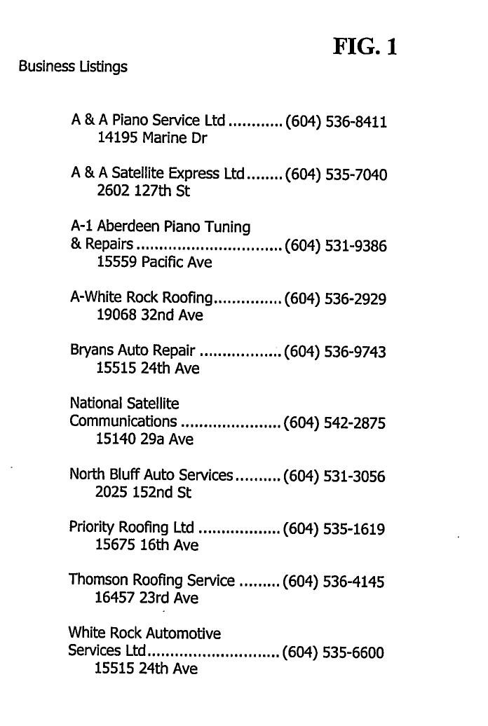

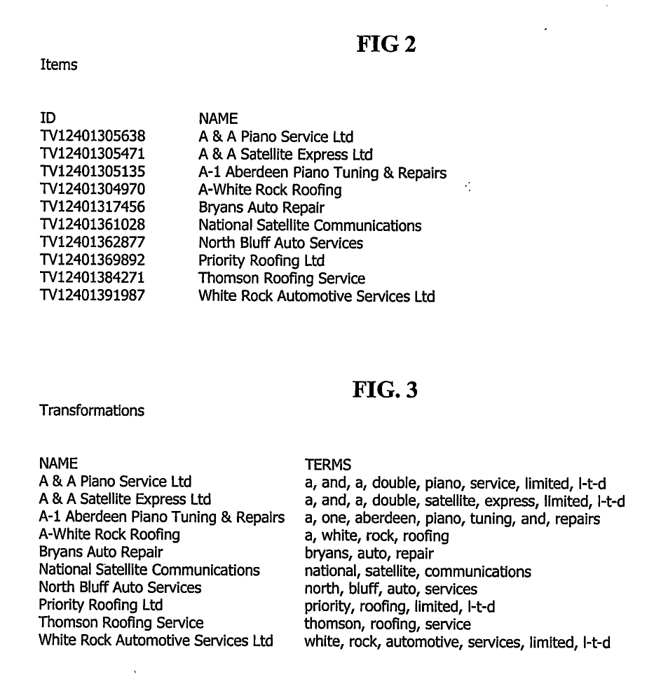

The items in the grammar which are represented go through a transformation process. In a directory assistance model, such grammar is usually created using business listings. FIG. 1 shows a typical sample of business listings and FIG. 2 shows the grammar items extracted from such listings. The purpose of the transformation process is to examine the item to be represented and apply adjustments to create a Word List appropriate to the grammar. The transformation process typically includes the expansion of abbreviations and the addition, removal or replacement of characters, words, terms or phrases with colloquial, discipline, interface, and or implementation specific characters, words, terms or phrases. The transformation process may add, remove, and/or substitute characters, words, terms and/or phrases or otherwise alter or modify a representation of the item to be represented.

The transformation process may be applied during the creation or other updating of the item to be represented, or at run-time, or otherwise when appropriate. Typically for large data sets and in the preferred embodiment, the transformation process is applied when the item to be represented is created and/or updated or in batch processes.

The transformation process calculates a series of terms (characters, numbers, words, phrases or combinations of the same) derived from the item to be represented.

In the preferred embodiment, if the transformation process is applied, it is preferable to implement the results of the process in a “non-destructive” manner such that the source item is not modified. It is preferable to save the result of the transformation process ensuring that a relationship to the item to be represented can be easily maintained.

FIG. 3 illustrates the result of a transformation process applied to the sample business listings of FIG. 1. The “Name” column identifies the item to be represented (i.e. the source item).

Several examples of particular transformations are present in this illustration. (1) The ampersand (“&”) is an illegal character in some speech recognition grammars, and, furthermore, is spoken as the word “and”. As such, the “&” is said to be “transformed” into “and” and applied to the “Terms” column. (2) The word “double” is present in the “Terms” column. The inclusion of this word in the “Terms” column will facilitate the use of the word “double” by a user to reference the item to be represented. This particular transformation allows for situations where the user may refer to “A & A Piano Service” and “Double A Piano”. (3) The terms “limited” and “1-t-d” are applied to the “Terms” column as an expressions of the term “Ltd.” (“l-t-d” being the interface specific representation for the speech pattern of a series of consecutive letters). In the illustration, the “Name” and “Terms” are columns of the same database table, each line representing a unique database row in the database table.

1. Word Map

A “Word Map” is generated from the either the result of the transformation process or directly from the item to be represented. The Word Map is a list of terms (herein called “words”) and corresponding references to the item to be represented. Each entry in the Word Map maps at least a single term and a reference to an item to be represented. As such, pluralities of the same term will likely appear in the Word Map.

Additional information may also be extracted and/or determined as appropriate for the given implementation. Such information may include data to facilitate the determination of words to include in the resulting grammar and/or data that may be useful in the interpretation of the resulting grammar.

In the preferred embodiment, it may be helpful to include a “Word Base” for each entry in the Word Map. A Word Base contains the base term of a given term. For example, the term “repairing”, “repaired”, “repair” may all share the same base term “repair”. Inclusion of the base term provides a level of flexibility when interpreting the resulting grammar.

In another embodiment, variations of a listing may be included to include the colloquial descriptions of the listing subject. For example the listing for “Langley SilverCity” may be also be referenced by the variations “Langley Theatre”, “Langley Cinema” and “Langley Movie Theater”. Each variation will be considered independently for inclusion in the dynamically generated grammar, and each variation will lead to the return of the same listing (in this case “Langley SilverCity”.

In the preferred embodiment, a “Use Count” is applied to each entry in the Word Map table. The Use Count articulates the total number of times a term is present in the Word Map. This facilitates rapid frequency analysis of the items in the Word Map.

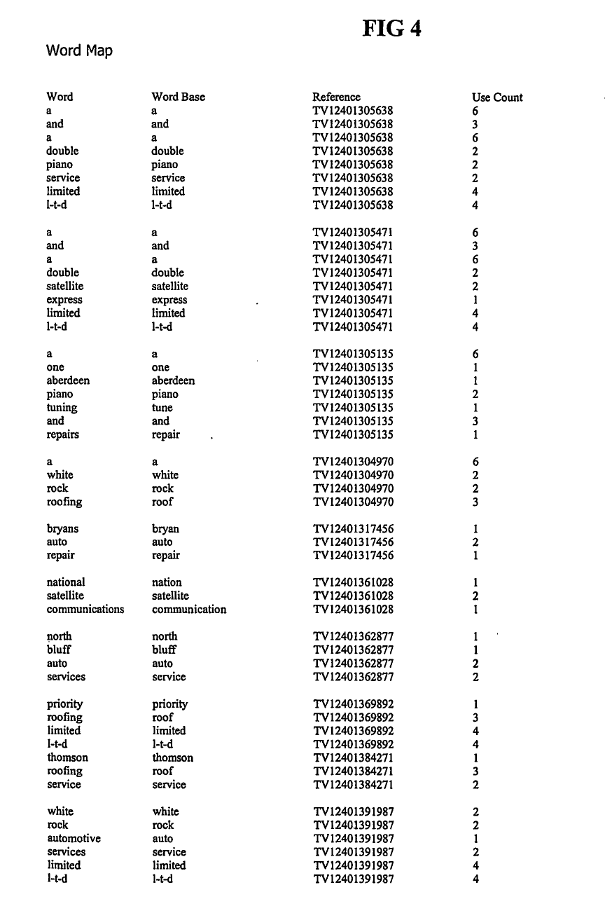

FIG. 4 illustrates a Word Map for a series of business listings typical in a business directory, yellow pages or directory assistance implementation. The “Word” column represents a specific instance of a term as matched to a specific item to be represented. The “Word Base” column represents the word base of a specific term. The “Reference” column represents the reference used to link the specific entry in the Word Map table to the item to be represented. The “Use Count” column indicates the total number of times the term appears in the Word Map.

2. Grammar Generation

An objective of the grammar generation process is to generate a single list of terms which can be used in a subsequent process to determine which items to be represented are being referenced while keeping the number of terms used in the grammar to a number suitable for practical application. The process commences by generating a list which contains all of the distinct terms from the Word Map, called a “Word List”.

If the number of items in the list is unsuitable for practical application (i.e. it is too large), the list is “trimmed”. The “trimming” process removes words based on usage frequency and other criteria from the list.

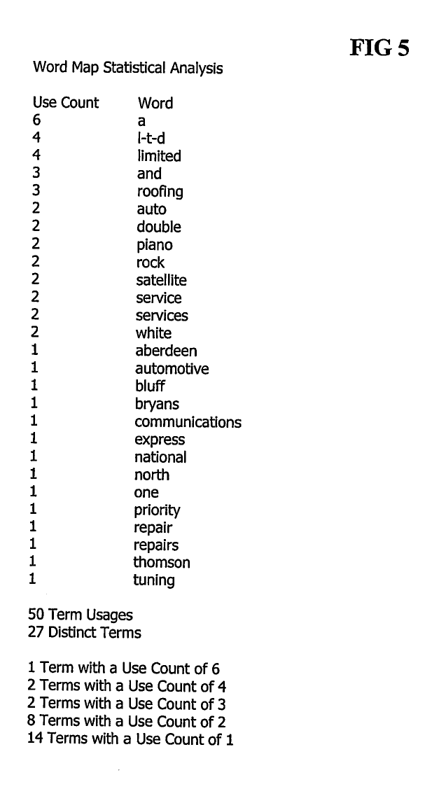

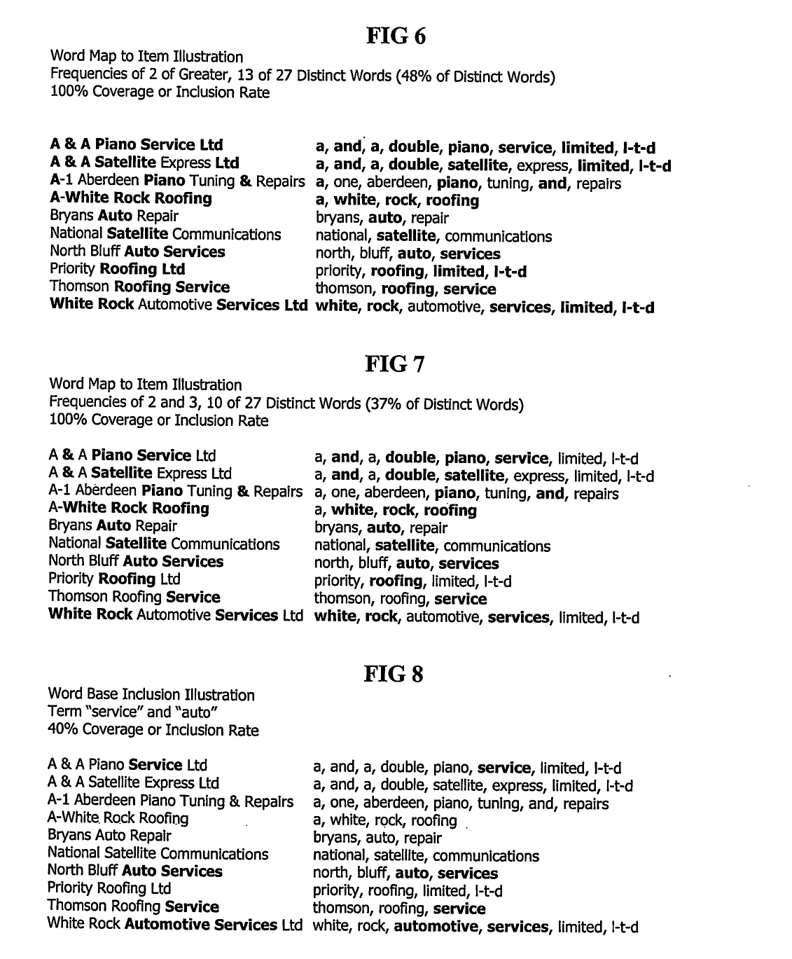

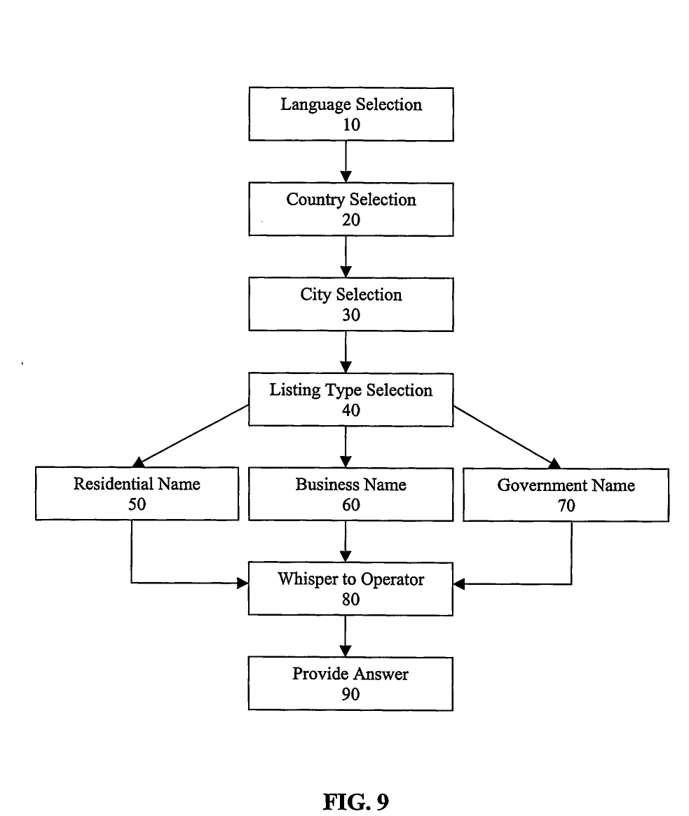

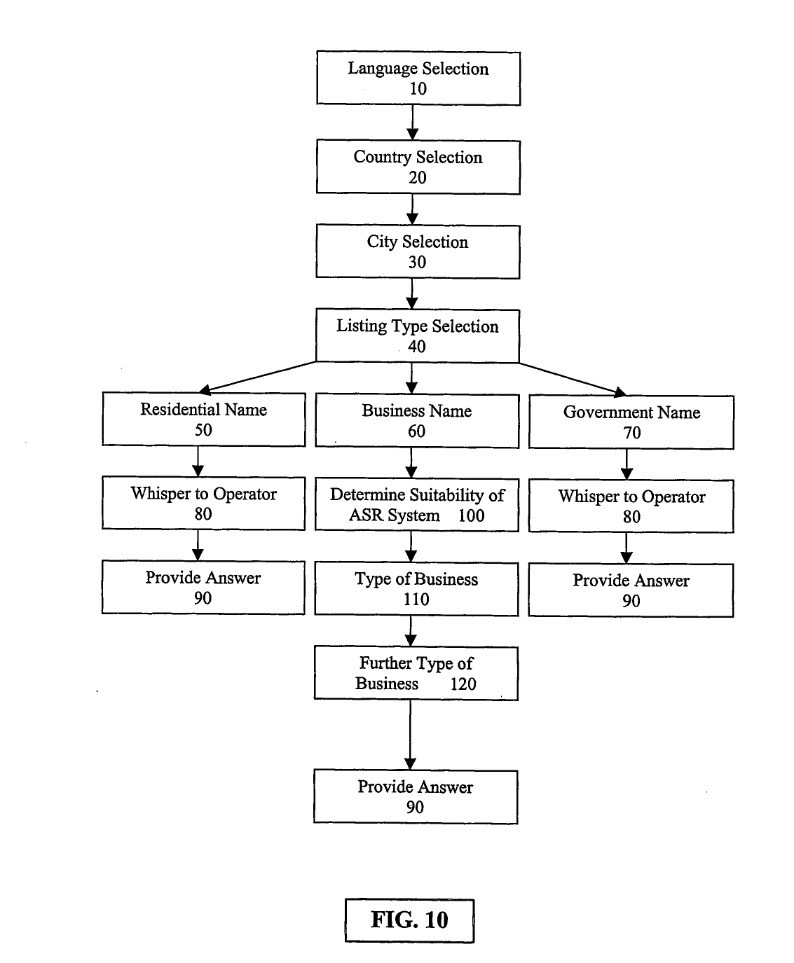

FIG. 5 illustrates a statistical analysis of the Word Map for the business listings of FIG. 1. The illustration depicts a “Use Count” column and a “Word” column where the “Use Count” articulates the usage frequency of a “Word” (or term) in the Word Map. As shown, the Word (or term) “a” has a usage frequency of 6, “l-t-d” of 4, “limited” of 4, “and” of 3, and so on.

As an example of the Grammar Generation process using the given illustration, let us assume the maximum practical size for a grammar is 25 terms (in real-word applications, the maximum size of a grammar is much larger but yet has a “practical” limit often dependent on a variety of factors). In such a model having more than 25 terms in the grammar results in slow processing of the speech. Furthermore, reducing the grammar from its maximum size to 15 or less allows the ASR system to perform in a manner suitable for implementation and practical purposes. Note that these numbers are used for illustrative purposes only and the method and system according to the invention is suitable for use with any size of grammar.

Using the illustration as depicted in FIG. 1, a prior art grammar would include a representation for each business name, for example “a and a piano service l-t-d”. Such a grammar would apply a “return result” of the ID of the business when it was recognized. A grammar following this model would consist of approximately 40+terms for the given illustrated list of businesses. Furthermore, this methodology of grammar generation does not easily support alternate terms or allowances for the user not using the exact terminology as reflected in the grammar.

Using the process disclosed herein, and following the example and illustration as depicted in FIG. 7, a grammar can be generated which could contain only 10 words (and therefore would not exceed the maximum viable size), but also, due to it's compactness and design, offer both speed and flexibility. Properly applied, the flexibility can be utilized to render significant accuracy.

Trimming is performed on the Word List by excluding or including terms, generally by, but not limited to, the criteria of usage frequency. Those skilled in the discipline will determine and/or discover other criteria which can be used to determine the inclusion of terms in the Word List.

In a preferred embodiment, the Word List should be approximately ⅓ proper names and ⅔ common names. Futhermore, the inclusion of words may be weighted by “frequently requested listings” so that more words from items frequently requested are included (for example golf courses, hotels and other travel destinations). Some words that are preferably included represent listings that are not necessarily frequent (i.e. they do not appear in a large number of listings), but they are sufficiently popular that they should be included in the Word List. An example would be a listing for a retail outlet such as a WALMART store. In addition some words appear so commonly as to have little value in dynamically generating the grammar. For example the word “Corporation” in a reasonably large city, even though it may appear in many listings, is unlikely to be useful in the trimmed Word List.

In an alternative embodiment of the invention, another method of determining the word list is to subdivide the original grammar into one or more smaller subgrammers. The subgrammars can be based on size (for example words with six or more letters are placed into one subgrammar and words with five or less letters are placed into another subgrammar). Other criteria for splitting the initial grammar can be used, such as alphabetical order, can also be used. The utterance is then passed through each smaller grammar, and each grammar produces a list of words recognized. These are amalgamated to continue the process as described below.

Once a final trimmed Word List has been determined, it is assembled into an ASR grammar following common practices. The result of a grammar utterance should be either the term itself, or the Word Base if such was applied. If the Word Base is the result of a grammar, enhanced flexibility for alternate and misspoken terms will be possible.

As known in the art, ASR grammar may contain “slots”. The trimmed Word List should be assigned to each slot, and the number of slots should be in congruent with the average number of terms or words among all of the items to be represented. For example, if the average item to be represented contains 5 words or terms, 5 slots should be assigned, each containing the trimmed Word List.

Those skilled in the art may use additional methods known in the art for the Word List or trimmed Word List generation in relation to slot position. Such enhancement can increase the accuracy of the process. For example, the process can be easily applied to generate a Word List or trimmed Word List by word or term position for each particular slot.

3. Grammar Interpretation

In the prior art, ASR is a “one pass” process: a grammar is generated, applied and the result is examined. The process according to the invention is a “multi pass” process: a grammar is generated which is designed to result in the generation of a one or more “latent grammars”.

The process requires that the spoken utterance or interface input is stored in a manner which can be re-applied. In the preferred embodiment, and using ASR, the speech is simultaneously “recognized” and “recorded” or obtained from the ASR recognizer after the recognition is performed. Depending on ASR and other implementation details, either method may be used. In the preferred embodiment, and when using ASR, the stored speech is re-applied in a manner which the caller cannot hear. This can be achieved in different manners, including but not limited to temporarily closing, switching or removing the audio out or applying the stored recognition in another context (i.e.: another process, server, application instance, etc.).

The result of the application of the grammar generated by the trimmed Word List or Word List is the term, or base term if used, of the Word Map. In some cases, as decribed, above the latent grammar can be formed out of the results of multiple passes through one or more subgrammars formed from the main grammar.

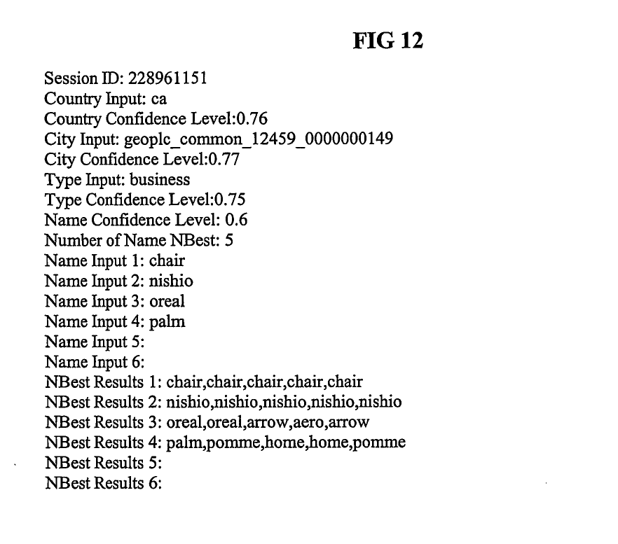

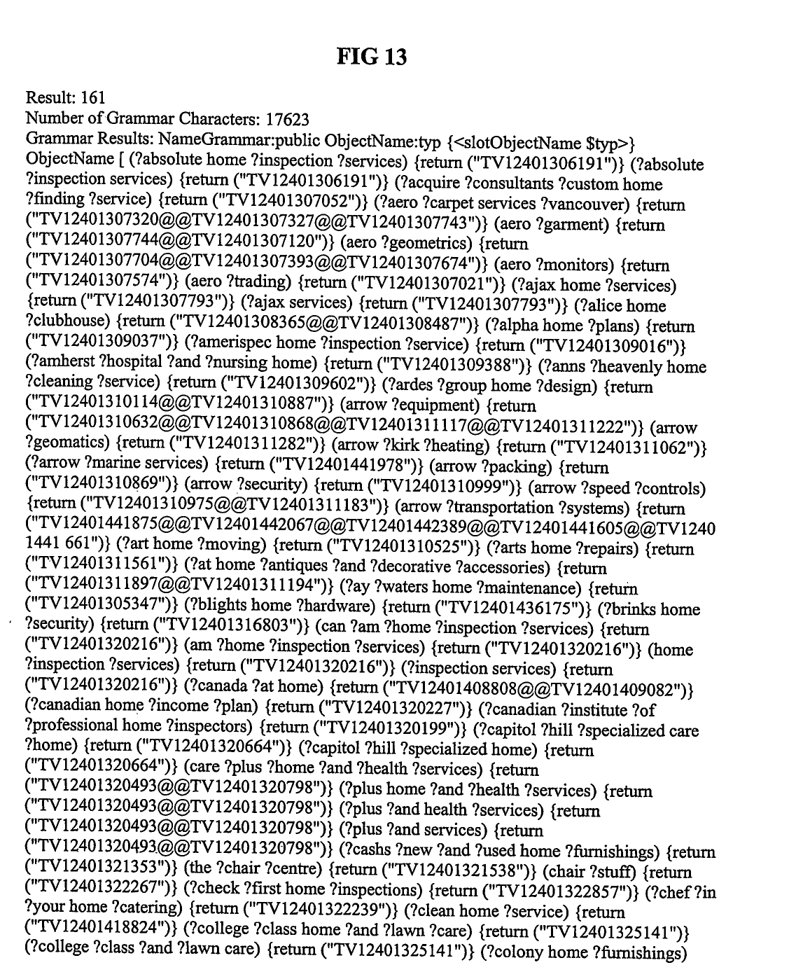

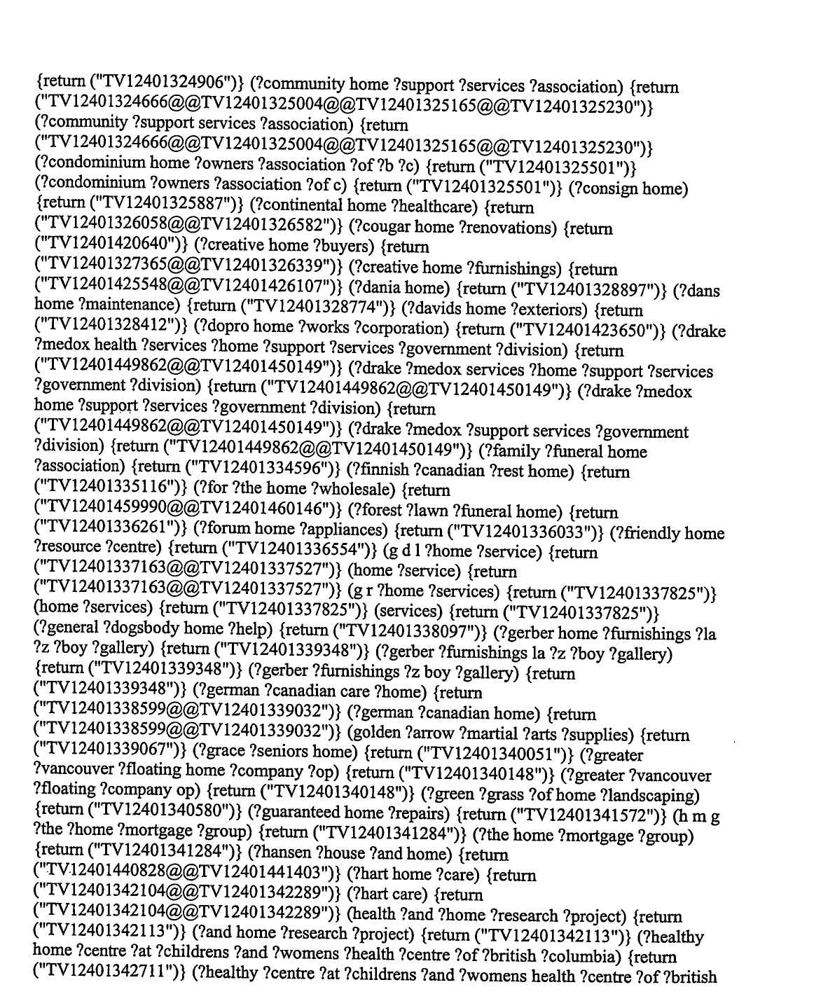

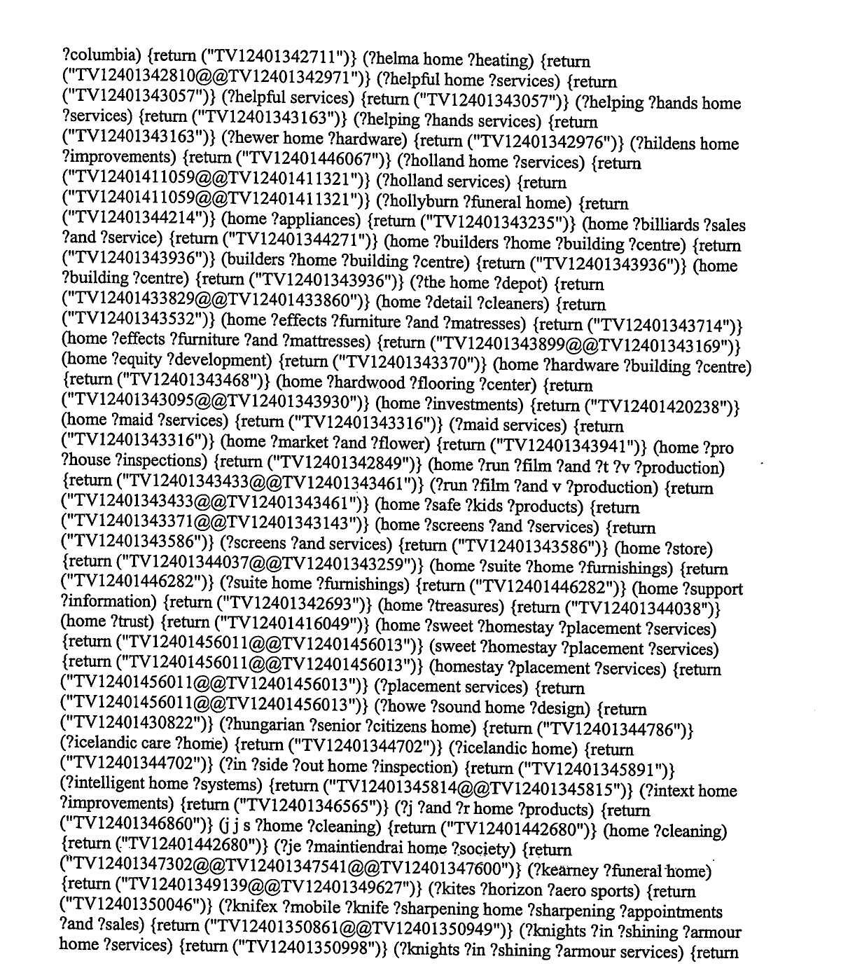

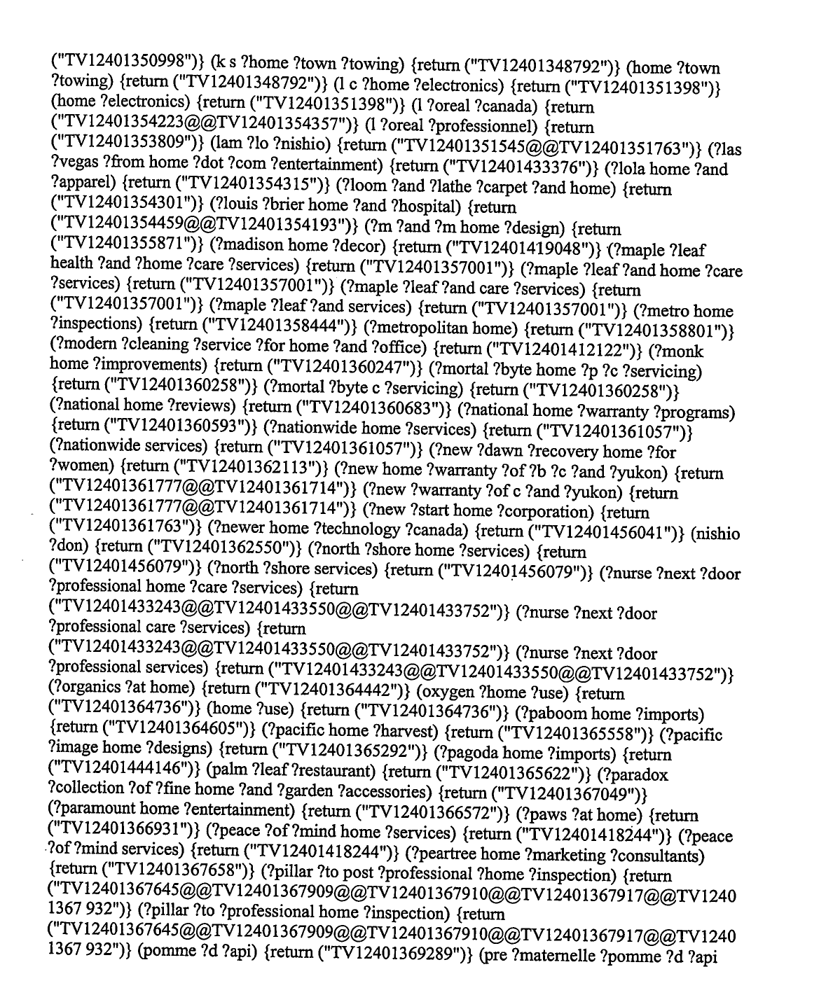

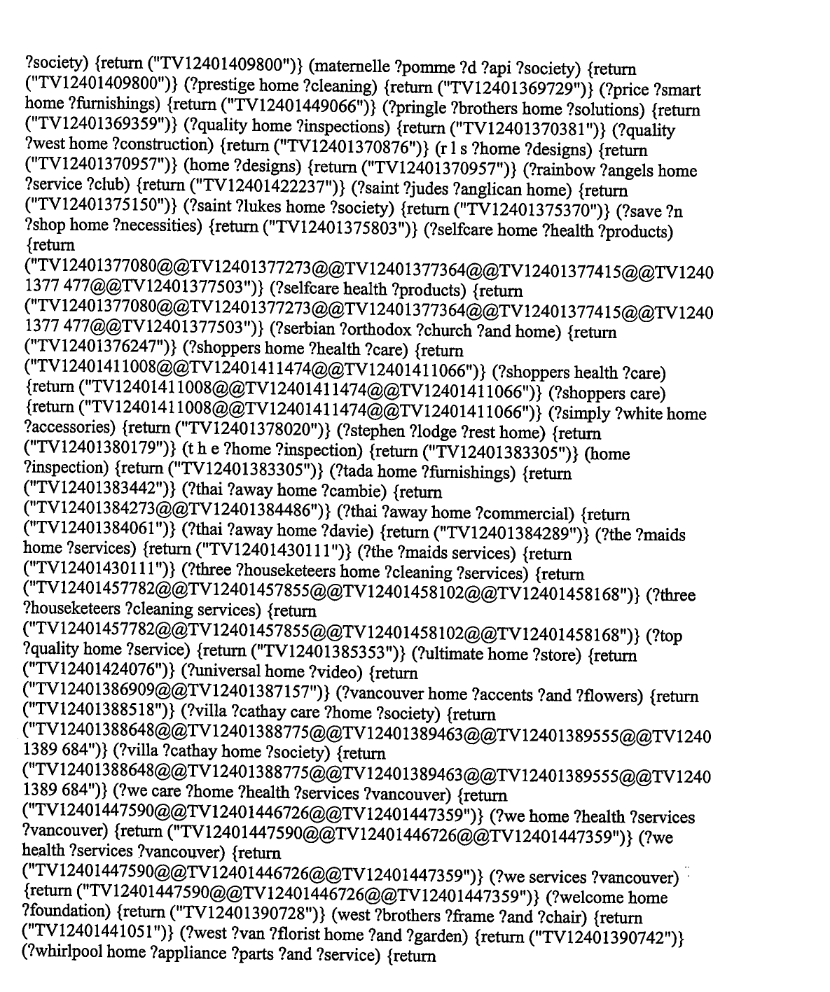

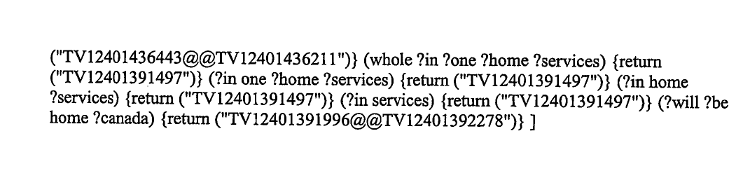

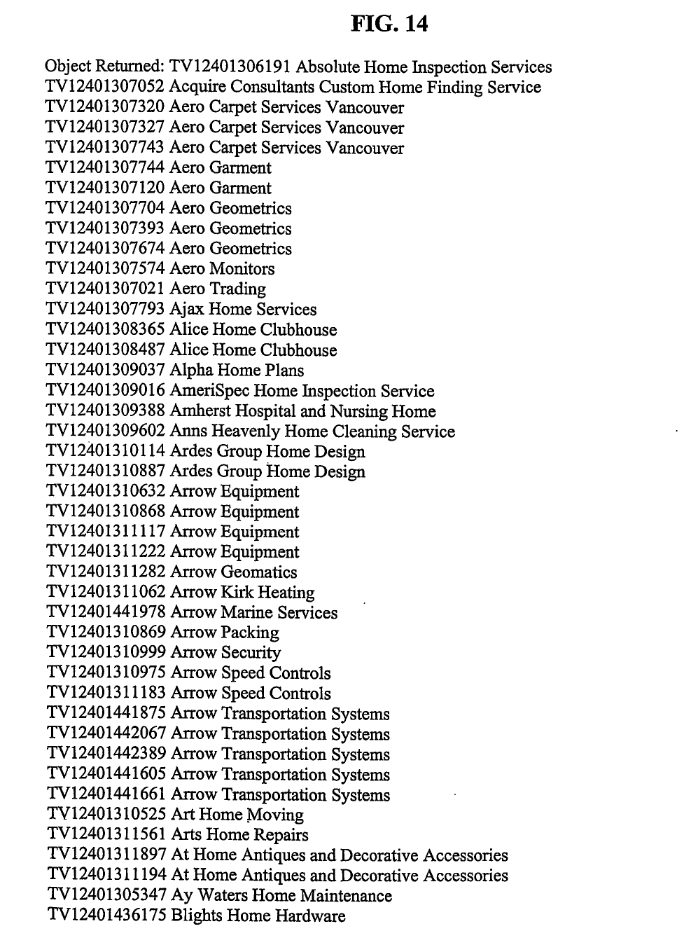

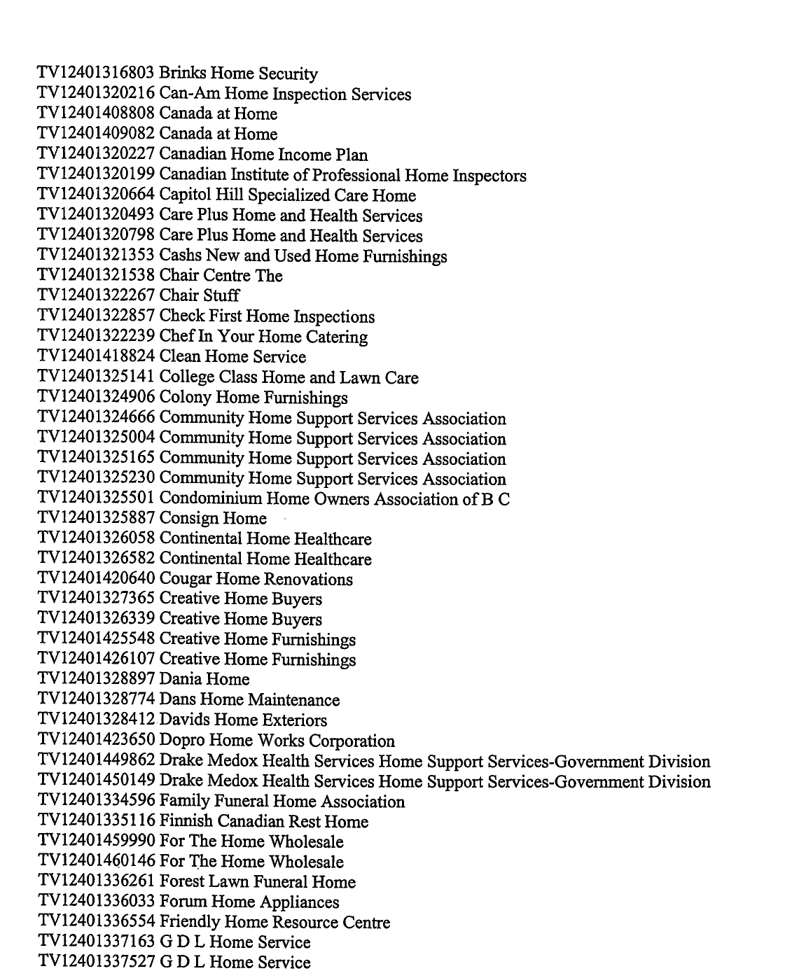

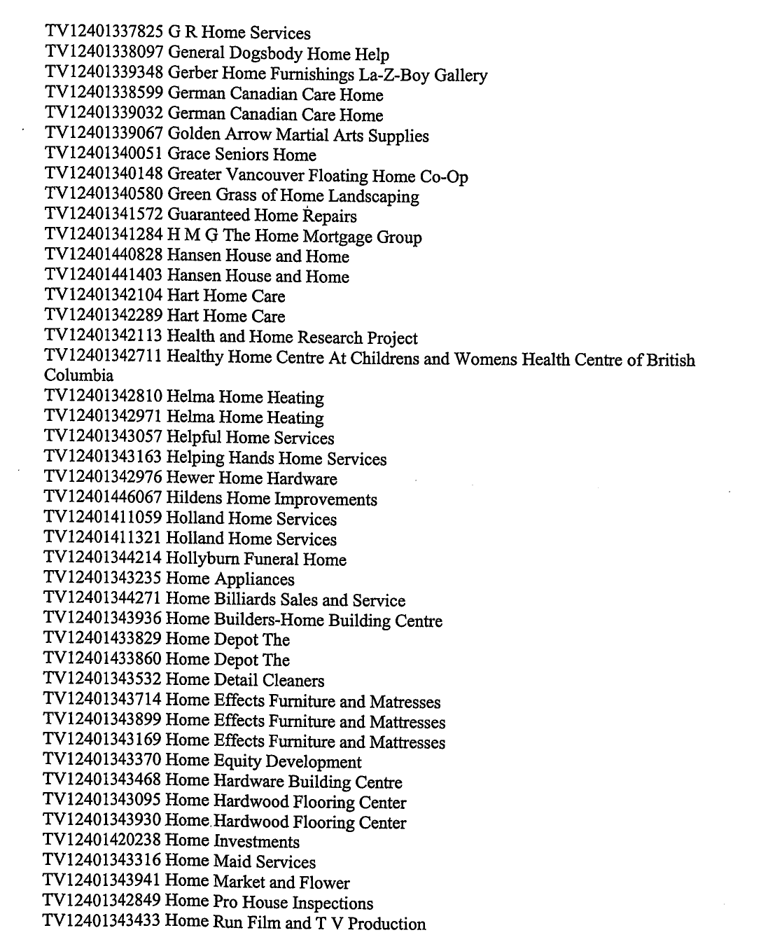

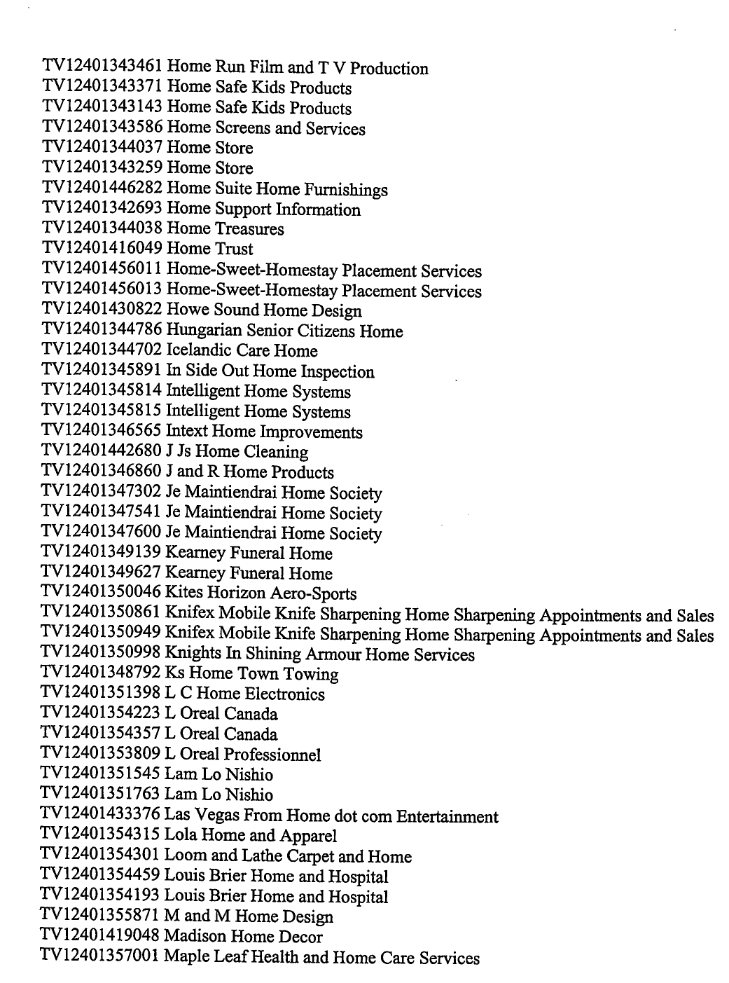

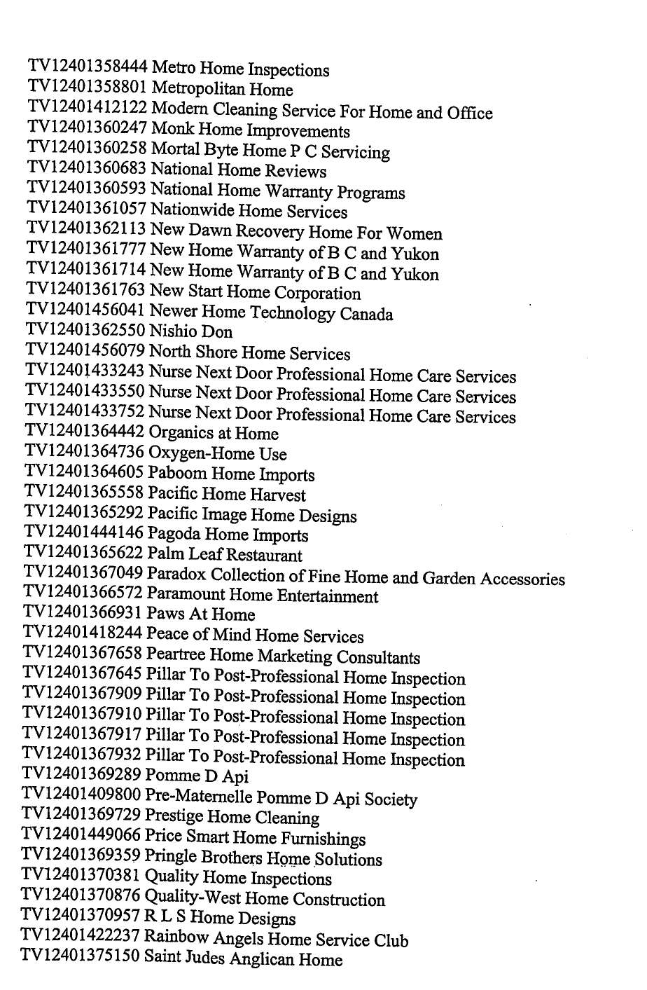

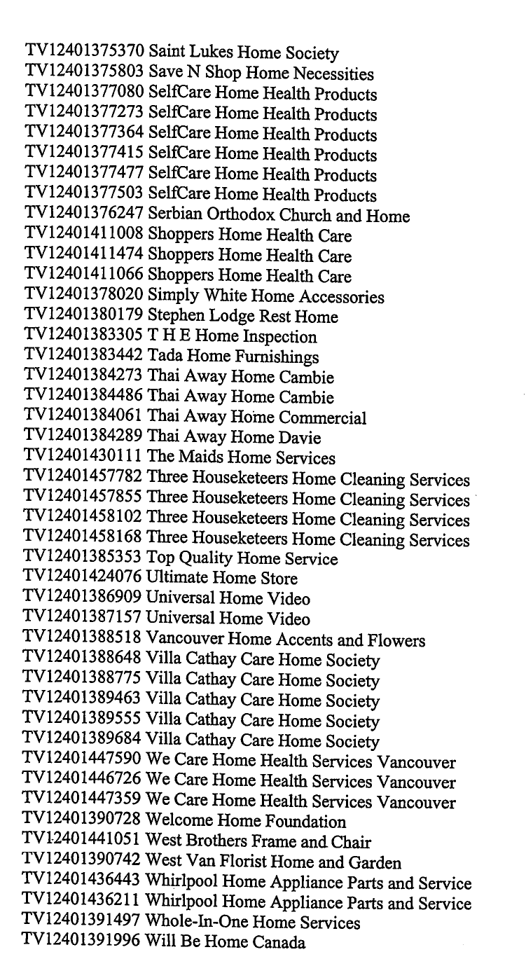

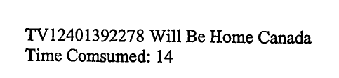

An evaluation of the grammar results may then be performed. In the preferred embodiment, “n-best”, a feature which returns the “n-best” matches for a given utterance, is applied such that multiple occurrences of a term may be returned. A list of grammar results and associated return result frequency and confidence scores can be assembled in a number of forms. Calculating the result occurrence frequency and obtaining the confidence score can be applied in a number of ways to effectively determine the relevance of items in the result set. For the purposes of an example, let us assume that the user responded to a request for Business Name with “Kearney Funeral Home”. As best seen in FIG. 12, the n-best results, after the ASR system has compared the utterance to the Word List includes the words “chair”, “nishio”, “oreal”, “palm”, “arrow”, “aero”, “pomme”, and “home”. Of these words, only “home” is found in the requested listing, “Kearney Funeral Home”.

The Word List is then scanned and all entries containing any of the n-best words (after the Word Map has been applied) are placed in a dynamically generated “latent grammar”.

It may be herlpful to add other words to the grammar, such as those associated with frequently request listings. For example, certain trade-marked words may be routinely added (such as WALMART). Likewise, the presence of certain words will imply that others should be included such as when the word “mall” is recognized, the term “shopping center” should also be added.

Certain words will also imply geographical relationships. For example the words “in”, “around”, “near” and “on” usually imply such a relationship. In these cases several advantages may be accomplished. For example, if the directory assistance service is advertiser supported a very targeted advertisement may be selected to play to the user. As well, the geographical reference can be used to check the accuracy of the result—does the address or location of the final listing returned have a relationship with the geographical reference? Furthermore, the word list created may treat the words following the geographical indicator as optional words nonessential to obtaining a match. The dynamic grammar will include references found by both including and excluding the geographical reference terms.

FIG. 4 depicts an example of a Word Map. In another example, if the results of the ASR interpretation of the utterance were “a”, “piano”, and “services”, A & A Piano Service Ltd; A & A Satellite Express Ltd; A-1 Aberdeen Piano Tuning & Repairs; A-White Rock Roofing; North Bluff Auto Services; and White Rock Automotive Services Ltd. would be the items included in the latent grammar because the Word Map entries for the utterance reference those items in their respective “Reference” values. These 6 items to be represented represent 60% of the total items to be represented.

If the number of item to be represented would generate a latent grammar which is still not practical for use, the Word Map may be recursively scanned, each time removing words which are least useful, until a latent grammar of the desired size is obtained. A latent grammar could be generated based on these items and latent recognition process could be performed. If, however, it was determined that the size resulting latent grammar would be too large or the process of generating the latent grammar would be too time consuming for practical application, grammar result trimming could be applied. Using the example above, the term “a”, could be removed due to its ambiguity or high usage frequency. This would in result the A & A Piano Service Ltd, A-1 Aberdeen Piano Tuning & Repairs, North Bluff Auto Services, and White Rock Automotive Services Ltd. being the items to be represented in the latent grammar because the Word Map entries for the results of the utterance minus the term “a” reference those items to be represented in their respective “Reference” values. These items to be represented represent 4 of the 10, or 40%, of the total items to be represented.

Other algorithms for grammar result trimming can be used as those skilled in the art will determine and/or discover. For example, word positions can be used to select which terms may be appropriate for inclusion or exclusion in the Word Map search.

The latent grammar is applied through a “latent recognition process” whereby the stored utterance used to invoke the result of the grammar is re-input against the latent recognition grammar. In essence, the same utterance is being applied the grammar is being changed from a broad non-specific grammar to a smaller, more specific grammar.

Referring back to FIG. 12, the results of the ASR process on the Word List (and incorporating the Word Map) returns a list of items. The items include the correct listing (“Kearney Funeral Home”) as well as listings that have little resemblance to the utterance (such as (“College Class and Lawn Care”). The addition of items that share a single word (and the Word Maps) mean that many of the items in the latent grammar will be very distinct from the utterance. In turn, this means that when the utterance is re-applied to the latent grammar, it is far more likely to obtain the correct answer.

Transparent Interface

In a voice recognition system according to the invention, one of the primary goals is to create a transparent interface, such that every time a requestor calls for assistance, whether the request is handled by voice recognition or by a human operator, the same pattern of questions will be provided in the same order. A typical prior art “store and forward” system is seen in FIG. 9. The user calls the information number (for instance by dialing “411”). The user then may select a language (for instance by pressing a number, or though the use of an ASR system), as seen in step 10. The user will then answer questions relating to the requested listing, such as country (step 20), city (step 30) and listing type (step 40), i.e. residential, business or government. The user will then be asked the name of the desired listing (step 5, 60 or 70). The answers to these questions will then be “whispered” to the operator (step 80). Ideally, the operator will be able to then quickly provide the listing to the user (step 90), or if the answers were not appropriate (for instance, no answer is provided), the operator will ask the user the necessary questions.

The traditional store and forward system is often combined with an ASR system, such that when possible the ASR system will be used. However, given the difficulties with prior art ASR systems, the user is asked different questions if an ASR system is used to respond to the inquiry. As seen in FIG. 10, if the user selects government or residential listing, a store and forward system is used to respond to the inquiry. However, if the user selects business listing, a determination is made as to the appropriateness of the ASR system. If the request is found appropriate for ASR determination (in step 110), for example, a grammar is prepared for the requested city, the user is then asked questions to reduce the grammar (for example the type of business in step 110). It may be necessary to further reduce the grammar by asking more questions (in step 120), for example by further determining a restaurant is being requested, and then asking the type of restaurant. Therefore, the questions asked the user vary depending on whether or not the user's request is considered appropriate for a determination by an ASR system or by a “store and forward” system.

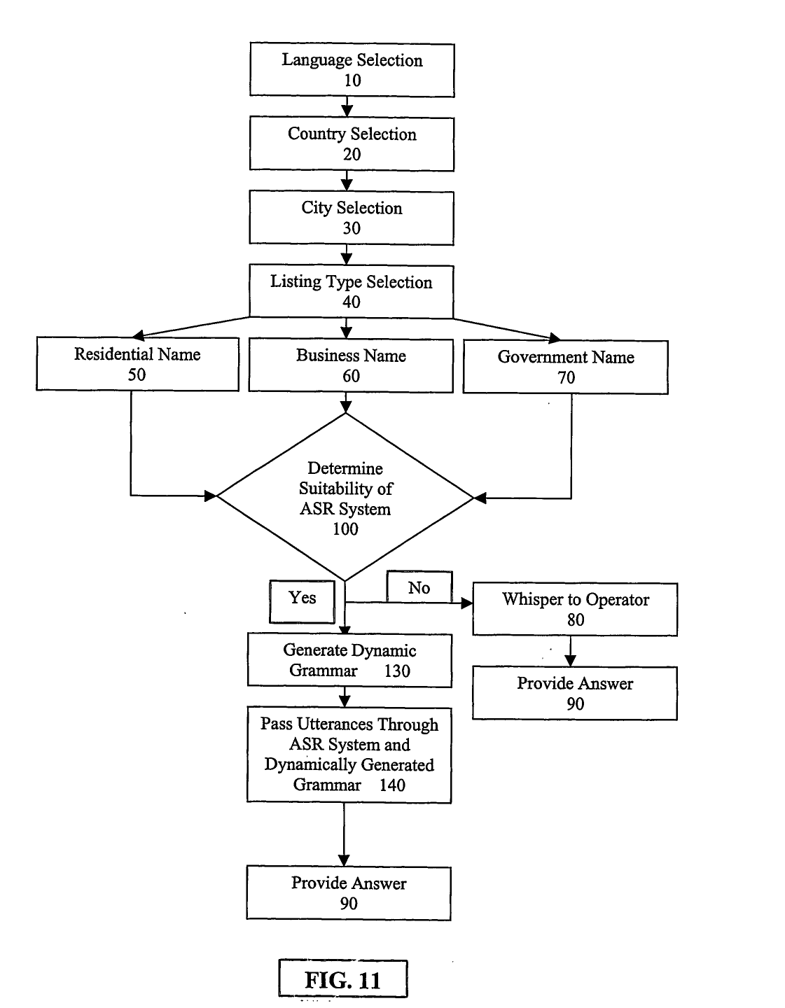

In a preferred embodiment according to the invention, the user is asked the same questions whether or not a store and forward or ASR system is used to determine the response. As seen in FIG. 11, the determination is made at the time the user has responded to the necessary questions (up to business name). If the ASR system is not suitable for a response, the questions are whispered to the operator. If the ASR system is appropriate, the utterances are run through a word list for the businesses in the selected city and a dynamic latent grammar is generated (step 130). Note that at this time and in the example provided, most ASR systems used in directory assistance applications are used exclusively with business listings, although they ASR systems can also be used with government of residential listings. The utterance is then run through the latent grammar (more than once if necessary) and an answer is provided. No additional questions need be asked to shrink the grammar. If the confidence of the ASR generated answer is not high enough (using means known in the art), then the responses to the questions can be whispered to an operator. In any case, no additional questions are asked, and whether an ASR or store and forward system is used, the experience will be invisible to the user.

Typically, the user will be asked if the answer provided is what he r she was looking for. If they indicate no, the answers will be passed to an operator using the “store and forward” system.

Gain Control

Another aspect of the invention is the use of gain control to assist the ASR system in determining the response to an inquiry. The volume at which the ASR system “hears” the utterance can have dramatic effects on the end result and the confidence in the correct answer. In a preferred embodiment, the ASR system will adjust the gain to reflect the circumstances. For example, if there is a high volume of ambient noise in the background, it may be preferable to increase the gain. Likewise if the spoken response is below a preset level, it may be preferable to increase the gain.

Another opportunity to use gain control is if the confidence of the result is below a preset level. In these circumstances it may be appropriate to adjust the gain and retry the utterance to see if the confidence level improves or a different result is obtained.

Furthermore, the preferred gain level for a source phone number may be stored, so that when a call is received from that source, the gain level can be adjusted automatically.

The ASR system can also be improved through additional audio processing in addition to or in place of gain control, for example by examining and adjusting for attributes particular to the utterance to be recognized and to enhance the audio which might be whispered to an operator in the event of an operator transfer.

Example of audio processing which may be applied:
1. “Normalization” wherein audio strength/loudness is made consistent across samples (this is especially effective if gain control is not used);
2. Trimming of the areas of the audio where no speech is present (e.g. at the beginning and ending of the utterance audio) or trimming of the areas of the audio between words (this reduces the time required by the ASR system or in providing the whisper);
3. Noise removal/reduction to remove artifacts which impair or hinder recognition or the whisper;
4. Various common audio filters, such as high and low pass filters, to otherwise enhance or improve the audio; and
5. Various complex process which analyse the utterance and remove portions which would hinder the ASR recognition. For example, in a directory assistance context, separating the portion of an utterance where the caller has spoken the name requested and provided a spelling of part of the name to remove the portion where spelling has been performed either to enhance the recognition of the name or apply another recognition process on the spelling. Both recognition processes can be used independently and optionally applied to generate a result.

Grammars can further be broken down into very specific classes, for example all of the pizza restaurants in a given locality, or all of the hotels. When certain keywords are recognized by the ASR system, the appropriate grammar can be used, and can be run through multiple passes as described above.

Use of the System and Method

In practical use the key constraints on ASR systems and the grammars used by such systems is time and accuracy. An ASR system can always be quite accurate, but in prior art systems this often takes more time than is desired. Of these two constraints, time is usually the most important, while accuracy comes second.

In the preferred embodiment of the system and method described herein, there are five steps in properly using the ASR system. These steps are:

1. Acoustic Analysis and Rendering

2. Interpretation and Execution Strategies

3. Lexical Pass

4. LRP Pass

5. Final Pass

6. Presentation

In Detail:

1. Acoustic Analysis & Rendering

The utterance is recorded and certain measurements are taken, for example the duration of the utterance, the rate of speech, and the loudness (expressed as Root Means Squared “RMS”). As described above, there are several options available to improve the chance of success of the ASR system in recognizing the utterance. For example, the utterance may be trimmed, for example by deleting dead spots. If appropriate the utterance can be compressed. The speech rate can also be changed, and the gain of the utterance can be adjusted. Another option is to modify a version of the utterance and run both the modified utterance and the original recording through the ASR system. This allows for multiple simultaneous passes of the same utterance, and if both are run through the ASR system an return the same result, the accuracy can be improved dramatically. Typically the utterance, for optimal performance, should be slowed down, and the volume increased.

The utterance, amended or unaltered, may also be “whispered” to an operator at this stage if the utterance has certain qualities that make it unsuitable for the ASR system, for example a large amount of background noise.

2. Interpretation and Execution Strategies

At this stage the ASR system monitors the current conditions and decides the appropriate course of action. Factors that should be considered are the characteristics of the audio input that make up the utterance, the resources (i.e. computing power) available, and the queue conditions (i.e. the current system usage). From this the time necessary to use the ASR system can be estimated, and a decision made as to use the ASR system or to whisper the utterance to an operator.

A key determination at this point is the quality of service to be offered to the user, which can mean the time within which the telecommunications provider will provide the requested information. For example, different companies may have different tiers of service levels for their customers. A user calling from a mobile phone will usually demand and receive the fastest service, and therefore is most likely to have his or her utterance whispered to an operator. At the other extreme, a caller from a phone booth will likely have a long tolerance for waiting, and has no easy alternative source of information and therefore the telecommunications provider will likely have the longest tolerance for offering a response. Therefore a user from a phone booth is most likely to be sent to the ASR system, which may have a longer (when compared to other quality of service levels) time to arrive at the answer. The quality of service level can also vary depending on the time of day, or the day of the week.

The system, when determining the appropriate treatment of an utterance, behaves very similarly as would an operator. It evaluates the utterance based on what was heard, taking into account words not heard completely. It can also “fix” the utterance, for example by making it louder, slower, deeper, etc. The utterance can also be “divided” into the various words, and can even be reordered.

3. Lexical Pass

If the system elects to use the ASR system (i.e. the system determines that based on the applicable constraints there is a reasonable likelihood of the ASR system returning a value within the preferred time), the ASR system runs the utterance through a lexical pass (using the grammar comprising the word list). This tends to be a very fast pass, as each word is identified the listings using that particular word (or applicable variations) are flagged for the latent recognition grammar. Other considerations in this pass include the language structure (i.e. nouns, verbs, adjectives, etc.) and the language structure class (i.e. proper/common nouns).

Another feature of the grammar based on the word list can be weighting the grammar towards more frequently requested listings (“FRLs”). Certain listings are more frequently requested, such as taxis, pizza restaurants, hotels and tourist destinations. This can be reflected by weighing such listings (and the words used in such listing that appear in the word list) so that they are more likely to be returned by the ASR system.

4. The LRP Pass

The utterance is then passed through the latent recognition process as described above. The latent recognition grammar is usually a small grammar and this step can be accomplished very quickly. Furthermore, certain words may trigger geographic referencing (such as the term “on”) which can be used by the system for accuracy (i.e. does the address of the listing correspond to a street referenced in the utterance). In some cases geographic referencing may be necessary (for example to locate a particular location of a restaurant chain).

If system resources are available, the utterance can be run through the ASR system simultaneously more than once. The utterance, as described above, may be modified for one or more of the simultaneous passes. The n-best results are determined for each pass.

5. Final Pass

The final pass is typically comprised of a grammar comprising only the n-best results from the LRP passes. Given the small size of this grammar, it can very quickly determine the best answer, and return a result with a confidence level.

6. Presentation

Given the strategies employed, the confidence level of the result and the quality of service level desired, the system can present the result to the user or send the utterance to an operator. A further feature of the system is that it can take advantage of normal hold times. For example if an utterance is run through the ASR system, but has too low a confidence level for normal presentation as the “correct” response, such utterance will then be whispered to the operator. However, while the utterance is in the queue for the operator, the result obtained by the ASR system, even with the low confidence level, can be presented to the user, preferably with a recorded message such as “Thank you for holding. While you were waiting I found . . . ”. Thus an ASR result with low confidence can be presented as a value added service. Alternatively, if the utterance is considered inappropriate for the ASR system (for example due to background noise), it is possible to whisper it to an operator, and simultaneously run the utterance through the ASR system. If the ASR system gets a result first, even at a low confidence level, it can be presented to the user. If the user accepts the result, the whispered utterance can be removed from the queue. If the utterance is not accepted the operator will soon come on line.

Adaptive Automation

Another feature of the present system is that it is adaptive and can be used in very different circumstances. For example the system can determine the frequency of the terms recognized in the first pass. If these terms are too common (for example a phone number for a popular chain restaurant without any geographic reference), the system can recognize this (as the term recognized will be flagged with a high frequency). As the ASR system is unlikely to provide the correct result, the system can then whisper the utterance to an operator.

The system described above provides a number of advantages. It is not dependent on the word order of the utterance. It does not use a fixed grammar structure (which limits the number of recognizable utterances). It is not based on a single very large grammar, which takes too long to compile and run. It can take advantage of linguistics (by using variations of the words in the actual listing), and can extract meaning from the utterance. Prior art ASR systems have been concentrating on “what was said” and have not been used in circumstances where what should be properly determined is “what was meant”.

The system can run several latent recognition passes (perhaps using amended utterances). If the dynamic grammar generated is too large, the system can complete several passes (for example each using a subset of the large dynamic grammar). Alternatively, as ASR systems are inherently unpredictable (i.e. they may produce different results from the same inputs), there may be benefits to running several passes of the latent recognition system on the same utterance. In practice if time permits these multiple passes can be run sequentially. Alternatively, if system availability permits, they can be run concurrently, and the result with the highest confidence level can be obtained.

Geographic References

The system and method described above can also serve to direct services to users or direct users to services. For example when a user requests the phone number of a taxi company, it is likely that user is actually trying to have a taxi sent to a particular location. The ASR system can be used with geographic recognition systems (for example as described in PCT Application No. PCT/CA01/00689 for a Method and Apparatus of for Providing Geographically Targeted Information and Advertising, which is hereby incorporated by reference). The system and method described herein can be modified to ask the user if they are looking for a service, e.g. a taxi, or the nearest hotel, and if so, they can be asked to give their location. Then after determining the location of the user they can be directed to the nearest hotel, or the closest taxi can be directed to them. This feature can be used with a number of services, including restaurants, pizza, laundromats, etc.

The geographic referencing can also be used to provide answers when the user gives incorrect information. For example, if the user asks for a listing that doesn't exist in a particular location, the system can look in neighbouring areas (for example a suburb) to determine if the appropriate listing is actually there. Also areas that have very similar sounds may be checked. For example if a reference can't be located in the town named “Oshawa”, the ASR system, time permitting can, then check the location “Ottawa”.

Self-Learning

It is common in the prior art to “train” an ASR system to recognize an individual user's utterances (as is commonly done with dictation programs). The system described herein also incorporates a self learning system. An advantage to the present system is that if the ASR process fails to arrive at the correct response, eventually an operator will handle the call and determine the “correct” answer (perhaps by obtaining more information from the user). In such a case the operator can also provide the correct answer to the ASR system, which can modify itself to “learn” from its mistake. This can allow the ASR system to “learn” regional dialects, accents, and unusual (but perhaps locally common) pronunciations.

Business Process

In the prior art, the traditional model of providing Directory Assistance services via telephone has been to charge users directly, typically at a fixed fee for each request made to directory assistance. By using the system described above a higher success rate of automation can be provided, which will reduce the costs of offering directory assistance. As the cost is reduced, a business case can be made for providing directory assistance to users at no cost, by using advertising.

There are several opportunities for advertisements to be presented to a user during the automation process as described above. When the phone is answered for example, an advertisement could be presented, for example “This service has been brought to you by company XYZ”. Another opportunity is available just before the number is provided to the user. Another opportunity is when the user is waiting during the processing of the utterance, and if the answer is being provided with visual information (such as via an MMS message to a cellular phone), there is yet another opportunity for an advertisement.

The making of a request for a business also provides an opportunity to target an advertisement. For example when a request is made for a restaurant in a certain geographic area, a competitor could present an advertisement with an inducement (e.g. a coupon or the like) in an attempt to lure that customer to a different establishment. The user will also be providing information about themselves based on the area from which they are calling and the call display information. By using the information available about the user and the listing the user is looking for, very precise advertisements can be presented to the user.

By selling this targeted advertising, it is possible for a service provider to provide directory assistance at a profit without charging users of the service for the calls. Given that the cost of the calls is a major constraint on the use of directory assistance services, by alleviating the cost, the demand for directory assistance will increase.

While the principles of the invention have now been made clear in the illustrated embodiments, it will be immediately obvious to those skilled in the art that many modifications may be made of structure, arrangements, and algorithms used in the practice of the invention, and otherwise, which are particularly adapted for specific environments and operational requirements, without departing from those principles. The claims are therefore intended to cover and embrace such modifications within the limits only of the true spirit and scope of the invention.
What is claimed is:

1. A method of matching an utterance comprising a word to a record in a database using an automatic speech recognition system comprising:
(a) forming a word list comprising a selection of words from said records in said database;
(b) using the automated speech recognition system to determine the best possible matches of the word in said utterance to the words in said word list;
(c) creating a grammar of records in said database that contain at least one of said best possible matches;
(d) using the automated speech recognition system to match said utterance to a record within said grammar.

2. The method of claim 1 wherein said database is a directory.

3. The method of claim 2 wherein said record is a listing.

4. The method of claim 3 wherein the word list includes transformations of said selection of words.

5. The method of on of claim 4 wherein the utterance is obtained by asking questions of a user.

6. A system for matching an utterance comprising a word to a record in a database using an automatic speech recognition system comprising:
(a) means for forming a word list comprising a selection of words from said records in said database;
(b) means for using the automated speech recognition system to determine the best possible matches of the word in said utterance to the words in said word list;
(c) means for creating a grammar of records in said database that contain at least one of said best possible matches; and
(d) means for using the automated speech recognition system to match said utterance to a record within said grammar.

7. A method of providing a listing to a user comprising:
(a) establishing communications with a user;
(b) asking questions of said user, and obtaining answers therefor;
(c) by using said answers, determining if an automated speech recognition system can determine the listing;
(d) using an operator to provide said listing if it is determined said automated speech recognition system cannot determine the listing;
(e) if said automated speech recognition system can determine said listing, having said automated speech recognition system do so.

8. A method of automatic speech recognition comprising:
(a) receiving an utterance;
(b) recording said utterance;
(c) attempting to recognize said utterance;
(d) if the recognition of said utterance is below a pre-set confidence level, adjusting the gain on said recording and re-recognizing said utterance.

9. A method of providing directory assistance to a user comprising:
(a) receiving an utterance from a user;
(b) determining a listing in response to said utterance;
(c) providing an advertisement to said user before providing said listing to said user;
wherein said user is not charged an additional fee for the directory assistance.
